(19) United States
(12) Patent Application Publication
(10) Pub. No.: US 2016/0224020 A1
(43) Pub. Date: Aug. 4, 2016

(54) SYSTEMS AND METHODS USING AN EVENT DESCRIPTOR FRAMEWORK

(71) Applicant: Siemens Product Lifecycle Management Software Inc., Plano, TX (US)

(72) Inventors: Kathleen deValk, Charlotte, NC (US); Amin Shah-Hosseini, Santa Clara, CA (US); Kevin Farmer, Charlotte, NC (US); Barry Etter, Mocksville, NC (US)

(21) Appl. No.: 14/988,239

(22) Filed: Jan. 5, 2016

Related U.S. Application Data
(60) Provisional application No. 62/110,233, filed on Jan. 30, 2015.

(51) Int. Cl. G05B 19/418

(52) U.S. Cl. CPC G05B 19/4183; G05B 19/41885; G05B 2219/31395; G05B 2219/31427

(57) ABSTRACT

Methods for product data management and corresponding systems and computer-readable mediums. A method includes receiving part data representing a plurality of parts, assigning a unique identifier to each of the parts, assigning at least one event to each of the parts, and storing the part data, unique identifiers, and events in an event descriptor framework (EDF) data structure.

### CROSS-REFERENCE TO RELATED APPLICATION

This application claims the benefit of the filing date of U.S. Provisional Patent Application 62/110,233, filed Jan. 30, 2015, which is hereby incorporated by reference.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved systems are desirable.

### SUMMARY OF THE DISCLOSURE

Various disclosed embodiments include an Event Descriptor Framework and related processes, systems, and computer-readable media. The Event Descriptor Framework (EDF), in various embodiments, is both a data structure and a framework designed to represent, process, and persist manufacturing quality data across the value chain. It is a part-centric, event-driven approach to managing data about product instances throughout the lifecycle of the product. This approach allows all data for product instances to be linked together to provide a unified 360 degree view of the product's lifecycle for the purpose of data exploration and analysis. It can be used to develop software applications to serve the needs of manufacturing customers as they track their product quality from cradle to grave both upstream and downstream through the value chain. This is unique within the manufacturing industry where most product quality data is distributed into many disconnected systems and stored in disparate data structures. Traditionally, to bring these disparate data sources together requires custom data integration systems and applications.

The EDF takes data from many disparate data sources and unifies it into a single, highly flexible and adaptive structure. It provides a data representation that can continuously adapt to the changing needs of the product brand owner. This is unique in the manufacturing industry as traditional systems use custom-built data structures or pre-defined data schemas that are specific to the given product owner and limit reuse.

The framework provides the ability to leverage the data for use in software applications. One benefit of the Event Descriptor Framework is rapid development of software applications that consume the data. It allows for a metadata-driven approach to data modelling and application development, de-facto maximizing code reuse. Generic applications can be built that consume any data stored in the Event Descriptor Framework's data structure. Since any type of manufacturing data can be represented in the EDF, applications built on top of it can be deployed and distributed to any manufacturer regardless of their data structures or data needs.

The Event Descriptor Framework as disclosed herein leverages highly scalable technologies to provide processing of very large data sets.

Disclosed embodiments include methods for product data management and corresponding systems and computer-readable mediums. A method includes receiving part data representing a plurality of parts, assigning a unique identifier to each of the parts, assigning at least one event to each of the parts, and storing the part data, unique identifiers, and events in an event descriptor framework (EDF) data structure.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates an EDF logical model as an Entity Relationship Diagram of a schema according to this exemplary embodiment; and

FIG. 3 illustrates a process in accordance with disclosed embodiments.

### DETAILED DESCRIPTION

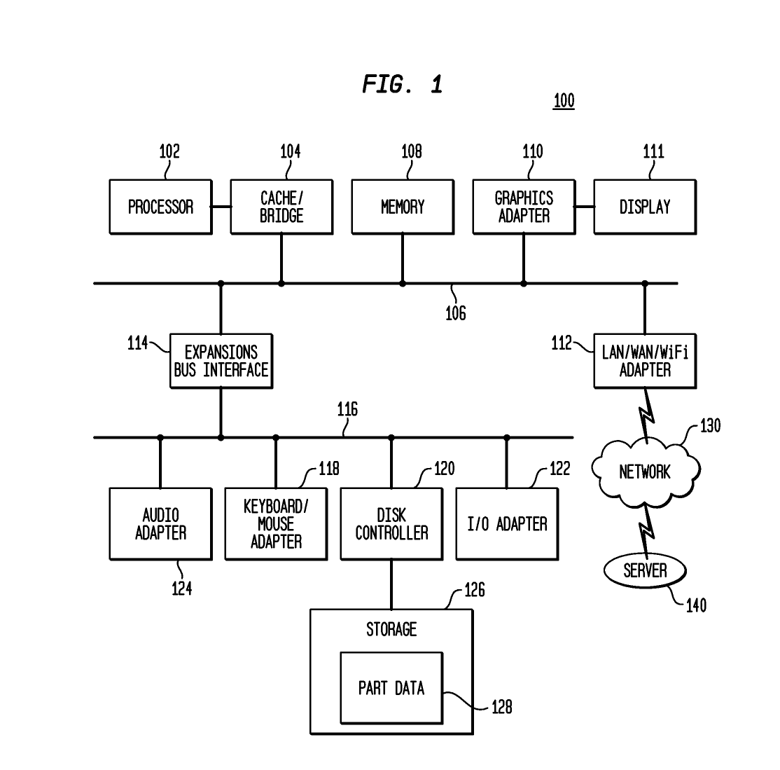

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

The EDF's data structure, in some embodiments, is a logical data model whose physical model is a serialization of data stored in a schema, such as defined by the Apache Avro™ 1.7.7 specification, available at time of filing at and hereby incorporated by reference. This provides a highly flexible approach to storing data where each “row” of data can contain a separate structure. The EDF includes the “part” that is being tracked and “events” that occur to the part. Each event is a serialization of what occurred to the “part” and all data points collected as a result of the event.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 126 or memory 108 can store any data discussed herein, including part data 128.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

As described above, the EDF can be a part-centric event-driven model. The “part” is represented using a unique identifier that uniquely identifies that physical object being tracked. This may be a product's “serial number”, for example. This is represented as part.identifier within the EDF data model. The part.identifier can hold any value the customer defines that uniquely identifies a product instance. This is handled through data mapping when customer data is transformed into the EDF structure. Those of skill in the art will recognize that the specific labels or names used herein are examples only, and disclosed embodiments are not limited to these exemplary names. Note that, in one notation used herein, a dot may be used to separate an element and a specific property or relation. For example, a “part” with the property “identifier” may be represented as “part.identifier”. The string that represents the actual part.identifier can be treated as an attribute of the identifier property of the part element.

Each data point is represented as an event. Events are things that happen to the part. For example, manufactured products are assembled, and this can be represented as an “ASSEMBLY” event. Each event encapsulates some default attributes as well as any custom attributes based on the needs of the customer's data.

The primary attributes, according to various embodiments, are:

TYPE: this is required and contains any value the customer determines is useful in categorizing what happened to the part at the time of the event. Examples include but are not limited to: “TEST”, “ASSEMBLY”, “REPAIR” etc.

PART: this is required and at least the part's unique identifier must be provided. It represents the physical object being acted upon during the event.

START_TIME: this is required and captures the point in time when the event occurred. If the event has a duration it can also have an END_TIME.

ACTOR: this is optional and represents who performed the action that the event represents.

LOCATION: this is optional and represents where the event took place. It is often used in manufacturing to provide the details of the factory where the event took place, for example an “ASSEMBLY” was performed at “FACTORY X”.

STATUS: this is optional but highly valuable to track the end state of the event. For example a “TEST” event may have a “STATUS” of “PASS” or “FAIL”.

Primary attributes can be leveraged by the software applications using EDF to provide general business logic.

All other attributes that are specific the customer or data source are custom properties and represented in a Properties List. Through the properties list any attribute the customer may need can be modeled, managed through the framework, and served to software applications.

Product genealogies for as-built as well as ongoing tracking of as-maintained products are managed within the EDF using PART.CONTENTS. Any part involved in an event can have contents that were involved in the event. Contents are other “parts” that are consumed by the parent part within an event. For example, in an ASSEMBLY event, contents are “added” or “inserted” into the parent PART. “REPAIR” events may have part contents which are repaired or replaced within the event. The contents are a list of other smaller PARTs which can be components or sub-assemblies that are combined together to build a product. An example is a computer that contains a hard drive and motherboard. The motherboard contains microchips and other components.

Various implementations can use the EDF model to traverse both the lifecycle of the product instances being tracked as well as the genealogy of the contents of a product. Using the framework, the software systems can follow the events that occur to the PART and access the entire event history for a PART. Similarly, because the EDF model is designed to track PART CONTENTS, the history of all the sub-components can be tracked.

The history of subcomponents is based on the concept that a PART's contents are actually other PARTs. Those PARTS can have events that occur to them and they are identified by a PART.IDENTIFIER. Therefore, the software systems that are built on the EDF can traverse the contents and then the history of the contents no matter the depth. For example, a computer has contents such as a motherboard. The motherboard is a PART and it may have events that occur to it, such as TEST and ASSEMBLY. The TEST events for the motherboard can be tracked as part of the history using the motherboard's PART.IDENTIFIER. The contents of the motherboard can be tracked from the ASSEMBLY event for the motherboard in which the motherboard's CONTENTs may contain a CPU. The CPU is identified in the motherboard's ASSEMBLY using the CPU's PART.IDENTIFIER. Using the same approach the history of the CPU can be tracked by traversing the motherboard's PART.IDENTIFIER. In this way one can traverse the lifecycle of all products, and their contents regardless of the depth.

Events are uniquely identified through a combination of the event TYPE, STARTTIME and PART.IDENTIFIER based on the notion that the same physical object cannot have the same type of action performed more than once at the exact same time. One can perform two different types of actions on the PART at the same time, but the same thing does not happened twice at exactly the same time. Note that STARTTIME can be as granular as milliseconds.

The implementation of the Event Descriptor Framework consists of a data serialization format as described above, an API to access data stored in this format, and a metadata-driven value selector framework written in JAVA that allows applications to access the data stored in this format for various purposes.

An Event Description Framework (EDF) is a collection of event data recorded in a database. As a data model, an EDF that contains objects called entities. Entities contain groups of similar members. In one example, there is a part entity that contains multiple instances of a part, each with a distinct serial number.

In this example, an event is defined as a change in an entity's status. Events are recorded in the data-base for reporting or analysis purposes. The part entity is acted upon during an event, such as testing or assembly.

An EDF can be viewed as similar to the W3C specification Resource Description Framework (RDF), which is used to express resource and entity data in a format that can be shared and consumed by different applications. A disclosed embodiment expresses events in a format that can be consumed by different processes, such as indexing, aggregating, running ad-hoc-queries, and so on.

An exemplary EDF contains two sections, each of which support one-to-many and hierarchical relationships in data:
Event Header—contains the primary attributes of the event:
   When the event started (start time)
   When the event ended (end time)
   What main entity was involved in the event (part)
   Who initiated the event (operator or actor)
   Where the event happened (location, such as factory, station, assembly line . . . )
Event Body—contains the details of the event. The only entity used in this example is part, therefore, the main entity of an event in this example is the top-level part.

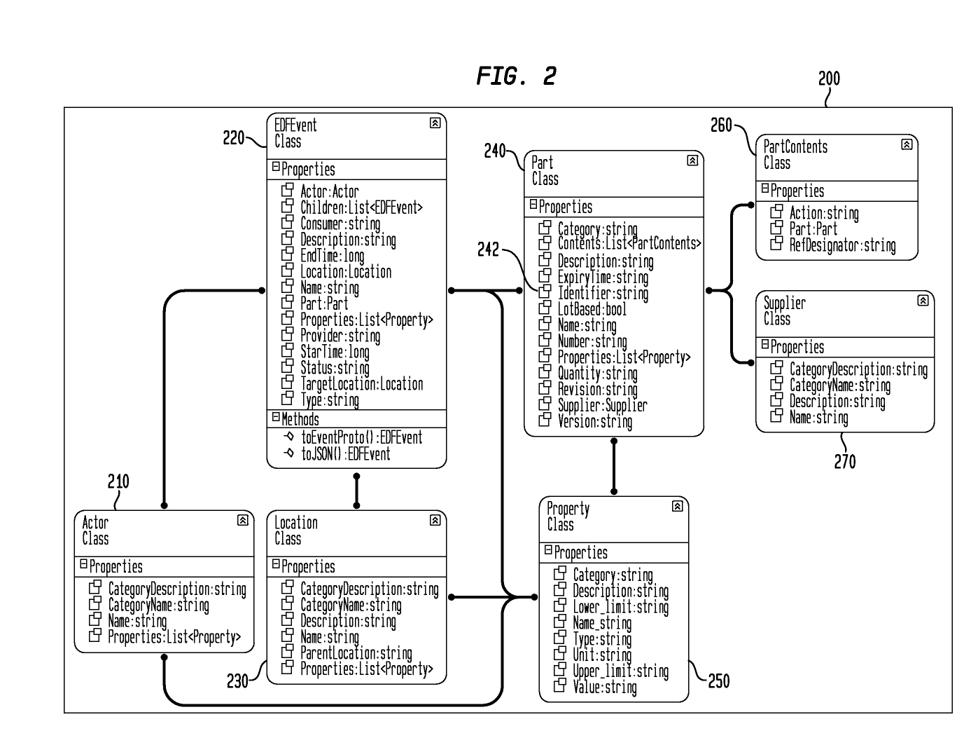

FIG. 2 illustrates an EDF 200 logical model as an Entity Relationship Diagram (EDS) of a schema according to this exemplary embodiment. The EDF 200, in this example includes classes including actor 210, EDFEvent 220, location 230, part 240, property 250, partcontents 260, and supplier 270. In this example, the part 240 has a property “identifier” 242 (also described as part.identifier herein).

EDFEvent 220 represents the EDF Event field (and may be also referred to generically as an event 220). EDFs provide a common format for storing data so that each software system can generate reusable code, which can, in turn, be used to process the data for other purposes. In addition to supporting code reuse, a common format for storing data supports the entire supply chain from all perspectives.

The EDF event field can be used for event tracking. Event fields can be used to capture key supply chain data. The following table defines the attributes of key event field names for an event 220 in this example:

| Event Field | Description |
|---|---|
| Type | categorizes events for processing, e.g., test, assembly, failure analysis (FA), |
| | return merchandise authorization (RMA), ship, etc. |
| Name | especially important for TEST events to see which tests passed and failed |
| Place | analysis is based on event location, e.g., station, assembly line, factory, etc. |
| Start Time | when an event begins, which is used for time-series analysis |
| End Time | when an event ends; event end time is optional, but recommended for |
| | calculating time differentials, such as how long a test takes |
| Actor | the title of the person who performs the event task, e.g., test operator, service |
| | analyst, etc. |
| Status/Outcome | the value that results from an event; a test, for example, results in a PASS or |
| | FAIL value which is used in KPI calculations or for NC identification. |
| What/Part | the entity acted upon during an event; the part.identifier is the globally |
| | unique sequence that represents the physical item involved in an event. |
| Event Category | categorizes similar events in logical groupings |

All event attributes, in some embodiments, can share a common semantic meaning within a given event type. For example, all tests should store the test name in event.name, and all tests should store the test outcome (pass/fail) in event.status. This practice drives the platform's ability to process all data for the entire supply chain in a consistent manner, with reusable code. The universal application of common semantic meaning to all event attributes allows common analytic processes to handle similar types of events. It is most effective to apply this practice to all
Tests
Subtests
Final product tests
Supplier's final product testing
Small subcomponents (e.g., CPU)

Hierarchical Events: Main events in an EDF can have subevents, called children. For example, when a test has a series of subtests, the subtest data is recorded as subevent or child-event of the main event.

Subtests usually establish a hierarchical relationship between the top level test and the set of associated subtests. Subtests are sometimes used to track steps or phases in a series of tests.

Test events with no need for hierarchical information are captured as separate test events.

Subtests can also be embedded as child-events for the purpose of maintaining the hierarchical relationship between the subtests and main test (parent test) and provide information for tracking and reporting purposes. For example, the Omneo product available from Camstar, a Siemens Business (Charlotte, N.C.) supports one level of nesting subevents (test, subtest).

Event nesting can be done during Extract, Transformation and Load (ETL). When one loads nested events into the system and index them for search, one can also index the subtest level as a separate document. This allows the system to count subevents at all levels. When the event is stored, a hierarchy level is calculated by traversing the depth of the event in the EDF and the calculated level is indexed as an attribute, which is useful for searching or filtering the data.

In various embodiments, each event 220 occurs to a single “part entity”. This part is a generic name assigned to the actual physical object that is acted upon during the event. For example, if cell phones are to be tested, a specific cell phone with a specific serial number will be involved in the test. This entity can be called a “part” for simplicity. In this example, the “part” refers to the actual product instance involved in the event. For example, a component supplier of hard drives provides tests of the hard drives to the purchaser. In this case, the “part” is the specific hard drive that was tested, and the event is the test that was conducted on it.

“PartContents” (or “part.contents”) 260 tracks product instances that contain other products. For example, a laptop contains a motherboard, hard drive, and so on. This field makes it possible to trace subcomponents back through the child-part's test history and trace all levels of the part genealogy including children, grandchildren, etc.

The part.contents field 260 contains specific attributes in this example:
Action—the action value makes it possible to track consumption, replacement, repair, dispatch, and so on. Here are some examples of action values:
   inserted
   dispatched
   repaired
   tested
The action value indicates how many child parts are inserted into top level parts via assembly events, or how many parts were dispatched for top level parts via an RMA.
The action value also makes it possible to track repairs. For example, if a laptop has a repair, and the repair was made to a child-part inside the laptop, the part.contents item for the child-part displays an action=repair entry. It expresses which child-part inside the laptop was repaired.
Part—the subcomponent, child-part, subassembly, etc. contained inside the main part involved in an event.
Ref/Designator—a reference designator is an attribute of Contents. It identifies where content is located within the parent or container. For example, the circuit board's microchips are accounted for with the PartContents field, which includes action=inserted, partt=microchip and refDesignator=the location on the circuit board where the microchip is placed.

Fast Contextual Search Subcomponent-Based Views: The part- or subcomponent-based view in a Fast Contextual Search (FCS) makes it possible to search nested contents of a part and view the contents as a simple list. For example, within an assembly event in which subcomponents are inserted into a parent part, the system adds a part.contents list to the assembly event. The part.contents list includes all sub-components added during the assembly event.

In the part-based view in both FCS and Performance Analytics (PA), the part.contents field extracts a list of contents for the parent part. In part-based views, the system displays only events that occur to parts that contain other parts.

The following is a JavaScript Object Notation (JSON) representation of an assembly event in which five components parts are inserted into a top-level product:

```
event: {type:”assembly”,
    name:”CUSTOM BUILD”,
    starttime: “Jan 23 2014 9:56:00 AM EST”,
    endttime: “Jan 23 2014 10:56:00 AM EST”,
part: { identifier:”ABC123”;
    name:”My Product”,
    number:”P1234”,
          .... Other attributes ....
    contents:[
    {action:”inserted”, lotBased:”false”,
          part:{identifier:”ZXY123”,
          name:”SubComponentName”,
          number:”C1234”,
          ....other attributes....}
          },
          {action:”inserted”, lotBased:”false”,
                part:{identifier:”ZXY456”,
                    name:”AnotherComponentName”,
                    number:”C4567”,
                    ....other attributes....}
}]}}
```

This JSON representation example indicates that, during an assembly event, two subcomponents are inserted into the product instance with serial number ABC123.

Genealogy Tracking Principles: Genealogy can be traced at multiple levels in various embodiments, beginning with, for example, a laptop that contains a motherboard which, in turn, contains microchips.

Tracking a product through its history and genealogy requires insight into both its event history and the product and product family genealogy, especially when defining multi-level assemblies.

An assembly event on the laptop might display part=laptop, part.contents.part=motherboard. A second assembly event (probably from the motherboard supplier) displays part=motherboard and part.contents.part=microchip for the chip inside the motherboard.

Drilling down from the laptop to its contents provides traceability for each part in the laptop's content through values in the part.identifier field. For example, a user can drill down to locate test event data on the motherboard contained inside the laptop, and further, to the microchip indicated in the contents, and trace that microchip's test history. Part contents linked to their respective event histories are critical to data mining and root cause analysis applications.

Subcomponent Tracking Principles: The EDF model allows for various ways to represent changes to a product and its contents and allows the system to track all events that change the contents of a product instance. This is important not only for calculating the current contents of a product instance, but also for tracking the history of a product's contents. The part.identifier property provides the capability to track events that involve parts at multiple levels. The part and part.contents event property contain a record of what happens to subcomponents within a part or product instance. This mechanism can be important when an event occurs to the top level part and additional action(s) also occur to its contents.

For example, an RMA received on a laptop might also involve changes to the contents of the laptop, as shown here:

```
event: {type:”RMA”, name:”laptop failure”, starttime:”Jan 23,
2014 9:35AM EST”,
    part:{identifier:”ABC123”,name:”laptopModel”,number:”LM1234”,
    contents:[{action:”removed”, part:{identifier:MB1234, name:”MB
    Model Y”, ...},
    {action:”inserted”, part:{identifier:MB5678, name:”MB Model Y”,
...}]P
```

In this example, the RMA indicates motherboard number MB1234 is removed, and motherboard number MB5678 is inserted.

Additional EDF Attributes: Additional attributes are captured for most primary EDF elements. This section is important for individuals involved in data integration and unification across the supply chains. Understanding how to consistently use these common attributes, and when to use a custom property, can be important to successful supply chain data integration and unification projects.

| Element | Description |
|---|---|
| Entity | An object stored in a data model |
| Event | A change in an entity's status |
| Event Header | Records data about the primary attributes of an event |
| Part 240 | The part property can represent a final product such as a laptop, or a |
| | subassembly, such as a motherboard, or a single component, such as a |
| | CPU. Part.identifier 240 represents the unique identifier of the part. |
| Property 250 | Stores detailed information about a part 240, such as the part's category, |
| | description, unit, type, etc. A Property 250 can further apply to and |
| | store information related to the event 220, the part 240, or any other |
| | entity in the event 220 (such as location 230, actor 210, and others, even |
| | a child part such as a part.contents.part). |
| Location 230 | Tracks where events occur based on the level of granularity required. |
| | Values for location include country, state, city, factory, assembly line |
| Actor 210 | Stores the title of the individual who performs a task for an event. Tests |
| | are often performed by operators, for example. These operators may |
| | have some name of other defining attributes. |
| PartContents 260 | Captures the contents of a part. It is used to store a list of part |
| (part.contents) | contents. A laptop, for example, includes a motherboard and hard |
| | drive, among other parts, in the part.contents field. |
| Action | Stores actions performed on a content element. For example, if an |
| | event is a repair to a laptop, the repair may fix some of the contents |
| | inside the laptop. The action field indicates the motherboard |
| | contained inside the laptop is repaired. |
| | The part field stores the details of the repairs made to the |
| | motherboard. When an RMA occurs to a computer and the contents |
| | are dispatched, the action field stores action = dispatched. |
| | When an assembly event inserts some parts into another part, the |
| | action field stores action = inserted. |
| RefDesignator | The refdesignator field identifies where content is stored inside the |
| | main part. A circuit board, for example, contains microchips as |
| | contents; therefore, its PartContents element includes |
| | action = inserted, partt = microchip, and refDesignator = the location |
| | where the microchip is placed on the circuit board. |
| Supplier 270 | This field captures the supplier of a part or the manufacturer of a |
| (part.supplier) | finished product. OEMs that assemble laptops for a company, for |
| | example, provide assembly events on the laptop (part) that include |
| | part.supplier = OEM's Name. In another example, a manufacturer |
| | provides a motherboard (part) to a company for assembly in a laptop, |
| | the part.supplier field stores part.contents.part.supplier = manufacturer |
| | of the motherboard. |

Faceting allows a user to group by a specific field (or attribute) to get counts of how many documents match each unique value of a field. In some embodiments, it can be important to never facet by high cardinality fields and, since a user can select any field to facet by, the user should configure which fields can be faceted to protect the system's stability and insure a high performing platform. A field is considered high cardinality when the majority of its values are unique. Ideally, for faceting: if one would not group by the field in SQL, then do not facet by it in the search engine. Faceting in a search engine equates to the “group by” function in SQL. Some examples of high cardinality fields, in this example, are start-time, part.Identifier and child.Part.Identifier.

Faceting by high cardinality fields is very expensive and can negatively impact memory caching and overall performance of a system, so it is important to configure which fields to allow faceting in order to protect the stability and performance of the platform. Preventing faceting on problem fields can help ensure the system performs at the highest levels.

Each facet field added to the user interface (UI), in some embodiments, creates a facet operation request to the database and the search engine counts and returns the top 3,000 matches for a field based on the total search criteria. Not adding too many facets to the user screen at once improves performance and puts less total load on the platform.

In some embodiments, it can be advantageous to facet by comments, description or freeform text fields, or to use a freeform field (text) in faceting. In some cases, it is preferable to only facet by fields with values that are single and specific, such as location, status, custom property, factory, part.category, and so on. Faceting on descriptions can be very taxing on the system and can have limited value. Freeform text fields make excellent search fields because one can search for words and phrases within these comments and description fields; however, freeform text fields are not a good mechanism for counting, since virtually all values are unique, with no two text fields identical. If these are used in a group by clause or facet by operation, it will tax the system while likely resulting in a count of 1. Instead, a user should only display the facets that are needed or use the Settings feature to set facets and save the search without affecting global settings.

In some cases, it is preferable not to facet by multivalued fields. It is important to understand the meaning of multivalued fields to know when to use them. In a search engine, a multivalued field is a single field that may have multiple values within the same document. For example, an assembly event may have a part.contents field that contains a list of parts (usually sub-assemblies or components) that are contained inside another part. A laptop, for example, may contain multiple components, as well as two or more of the same component, such as memory chips. If a field such as childPartName is indexed from EDF part.contents.part.name as a multivalued field, each value from the list of contents is indexed for that document. This means that a user can search for assembly events that contain one or more of these parts; faceting the top level events by this field, however, can result in misleading counts because each document is counted once for each value that appears in it. This issue can be avoided by using the Event View, in which the subevents are indexed, so to facet by a nested event attribute will not be necessary. In Part View, the flattened contents guarantee one-to-one mapping on part.contents to a document, therefore, a user can facet on attributes of the contents.

In such cases, accuracy can be important. Multi-valued fields can give misleading counts if not used properly. Faceting by part.contents.part.name (or any custom property of the part contents) results in different counts depending on the view selected.

The following are standard components of an exemplary schema as illustrated in exemplary EDF 200.
Part Contents 260
   Action: string
   Part: Part
   RefDesignator: string
Supplier 270
   CategoryDescription: string
   CategoryName: string
   Description: string
   Name: string
Part 240
   Category: string
   Contents: List<Part Contents>
   Description: string
   ExpiryTime: string
   Identifier: string
   LotBased: bool
   Name: string
   Number: string
   Properties: List<Property>
   Quantity: string
   Revision: string
   Supplier: Supplier
   Version: string
Property 250
   Category: string
   Description: string
   Lower_limit: string
   Name: string
   Type: string
   Unit: string
   Upper_limit: string
   Value: string
EDFEvent 220
   Actor: Actor
   Children: List<EDFEvent>
   Consumer: string
   Description: string
   EndTime: long
   Location: Location
   Name: string
   Part: Part
   Properties: List<Property> Provider: string
   StartTime: long
   Status: string
   TargetLocation:
   Location Type: string
Location 230
   CategoryDescription: string
   CategoryName: string
   Description: string
   Name: string
   ParentLocation: string
   Properties: List<Property>
Actor 210
   CategoryDescription: string
   CategoryName: string
   Name: string
   Properties: List<Property>

An EDF as disclosed herein can use a hierarchical nesting of the parent child relationships. This nesting provides the linkage that allows traversal from the finished products to the component parts that comprise those products.

Various embodiments use a dynamic schema approach to managing data attributes. Data attributes are not pre-defined within the system but they are derived from the data being fed into the system. The PROPERTIES element of EDF can enable this flexibility. How a system provides for defining and consuming custom properties will give an indication if the principles of EDF are being applied to manage and process data.

Various embodiments use a proprietary value selector as a part of the framework. This provides for the configuration driven processing of the data.

An Event Descriptor Framework as disclosed herein provides a foundation for rapidly developing customer-centric applications for the purpose of solving product quality issues across the Value Chain. This framework can improve systems by providing a common, consistent data storage and processing system that can be reused for many purposes. Once data is structured and stored in the EDF format, the framework can be used to process, traverse and analyze any data repeatedly without code customization. The framework allows for a configuration driven methodology to contextualize the data for the end users via a dynamic schema that can be adapted as the needs of the customer or users change without requiring new code or development.

Due to the highly flexible nature of this framework, applications built on top of the framework can be adapted and sold to any manufacturer, brand owner, supplier or any entity across the Value Chain without custom code or implementations. Differences in end user needs, data structures, and business context can be managed through configuration rather than custom implementations. Value Chains can now be fully connected through the data. This provides access to a large market of potential customers.

By leveraging the simple business logic within the framework that ties finished goods back to their component parts, the EDF provides a revolutionary way to traverse the Value Chain data up-steam and down-steam and tie together key attributes that impact the quality and effectiveness of the products being tracked.

In addition to the above, the EDF can easily be adapted to other industries or software systems that need to handle data about physical entities, events that occur to those physical entities and hierarchical relationships between physical entities. If the physical entity being tracked can be uniquely identified, then the EDF can be used to model and process almost any type of data and can be leveraged to build many software applications. This makes it a very valuable data storage and processing framework. An example is a system can use the EDF to store usage data and feeds application logs into the system as events occur to the user. In this case the user is the PART and their PART.IDENTIFIER is the user name. Using this methodology one can track activities of users as events and use the same underlying storage and processing engine to analyze usage patterns.

Some approaches to managing this data include custom applications, data warehousing and relational database systems. The EDF is designed to be self-contained, flexible and dynamic. The schema changes with the data unlike other relational systems or data warehouses where the schemas are predefined and data is loaded into the predefined structures. In addition, the EDF consists of self-contained records with all attributes related to the event stored in a hierarchical, de-normalized structure. It is designed specifically to model multiple disparate data sources within a single model and flexible enough to handle most any type of data. The EDF is structured and designed to be highly scalable.

Some big data platforms can process disparate data sources, however the EDF provides the storage, serialization, framework for processing and APIs that provide a metadata layer for applications in a complete solution. Other similar systems require implementation on top of the storage layer. The EDF encapsulates the knowledge of how to store, read, and process the data within its framework. This allows applications to use a metadata-driven configuration for linking data to the application tier without custom implementations.

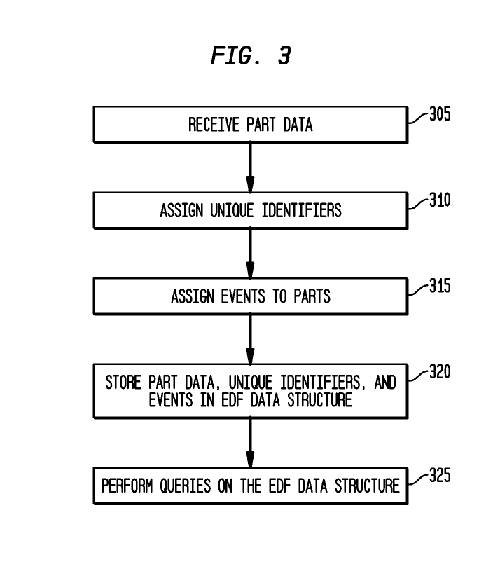

FIG. 3 illustrates a process in accordance with disclosed embodiments that can be performed, for example, by a data processing system 100, referred to as the “system” below.

The system receives part data representing a plurality of parts (305). “Receiving,” as used herein, can include loading from storage, receiving from another device or process, receiving via an interaction with a user, or otherwise, and can specifically include receiving the part data from a plurality of different sources.

The system assigns a unique identifier to each of the parts (310). This can be the part.identifier discussed above.

The system assigns at least one event to each of the parts (315). Events can be further identified by attributes such as type, part, start time, end time, actor, location, and status.

The system stores the part data, unique identifiers, and events in an event descriptor framework (EDF) data structure (320).

The system performs queries on the EDF data structure (325). This step can include indexing one or more EDF data structures, receiving a user query, searching the one or more EDF data structures, and returning a response to the user based on the user query and the results of the search. The response can be stored in the system, displayed to the user, or transmitted to another data processing system.

In various embodiments, each of the events describes an event that happens to the respective part. In various embodiments, each event includes default attributes and custom attributes. In various embodiments, each event includes one or more events selected from type, part, start_time, end_time, actor, location, and status. In various embodiments, the EDF data structure manages product genealogies for the parts. In various embodiments, each event is uniquely identified by a combination of type and start_time attributes and the corresponding unique identifier. In various embodiments, the EDF data structure is a logical data model having a plurality of rows, each row containing a separate data structure.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method for product data management, the method performed by a data processing system and comprising:
receiving part data representing a plurality of parts;
assigning a unique identifier to each of the parts;
assigning at least one event to each of the parts; and
storing the part data, unique identifiers, and events in an event descriptor framework (EDF) data structure.

2. The method of claim 1, wherein each of the events describes an event that happens to the respective part.

3. The method of claim 1, wherein each event includes default attributes and custom attributes.

4. The method of claim 1, wherein each event includes one or more events selected from type, part, start_time, end_time, actor, location, and status.

5. The method of claim 1, wherein the EDF data structure manages product genealogies for the parts.

6. The method of claim 1, wherein each event is uniquely identified by a combination of type and start_time attributes and the corresponding unique identifier.

7. The method of claim 1, wherein the EDF data structure is a logical data model having a plurality of rows, each row containing a separate data structure.

8. A data processing system comprising:
a processor; and
an accessible memory, the data processing system particularly configured to:
receive part data representing a plurality of parts;
assign a unique identifier to each of the parts;
assign at least one event to each of the parts; and
store the part data, unique identifiers, and events in an event descriptor framework (EDF) data structure.

9. The data processing system of claim 8, wherein each of the events describes an event that happens to the respective part.

10. The data processing system of claim 8, wherein each event includes default attributes and custom attributes.

11. The data processing system of claim 8, wherein each event includes one or more events selected from type, part, start_time, end_time, actor, location, and status.

12. The data processing system of claim 8, wherein the EDF data structure manages product genealogies for the parts.

13. The data processing system of claim 8, wherein each event is uniquely identified by a combination of type and start_time attributes and the corresponding unique identifier.

14. The data processing system of claim 8, wherein the EDF data structure is a logical data model having a plurality of rows, each row containing a separate data structure.

15. A non-transitory computer-readable medium encoded with executable instructions that, when executed, cause one or more data processing systems to:
receive part data representing a plurality of parts;
assign a unique identifier to each of the parts;
assign at least one event to each of the parts; and
store the part data, unique identifiers, and events in an event descriptor framework (EDF) data structure.

16. The non-transitory computer-readable medium of claim 15, wherein each of the events describes an event that happens to the respective part.

17. The non-transitory computer-readable medium of claim 15, wherein each event includes default attributes and custom attributes.

18. The non-transitory computer-readable medium of claim 15, wherein each event includes one or more events selected from type, part, start_time, end_time, actor, location, and status.

19. The non-transitory computer-readable medium of claim 15, wherein the EDF data structure manages product genealogies for the parts and is a logical data model having a plurality of rows, each row containing a separate data structure.

20. The non-transitory computer-readable medium of claim 15, wherein each event is uniquely identified by a combination of type and start_time attributes and the corresponding unique identifier.
